(19) United States
(12) Patent Application Publication
(10) Pub. No.: US 2015/0288834 A1
(43) Pub. Date: Oct. 8, 2015

(54) PORTABLE TERMINAL, AND CONTROL METHOD FOR PORTABLE TERMINAL

(71) Applicant: Canon Imaging Systems Inc., Niigata-shi (JP)

(72) Inventors: Fuyuki HOMMO, Niigata-shi (JP); Satoshi NEGISHI, Niigata-shi (JP)

(21) Appl. No.: 14/744,249

(22) Filed: Jun. 19, 2015

Related U.S. Application Data
(63) Continuation of application No. PCT/JP2013/085326, filed on Dec. 25, 2013.

(30) Foreign Application Priority Data
Dec. 27, 2012 (JP) 2012-284993

(51) Int. Cl. H04N 1/00; G06F 3/14; G09G 5/00; H04M 1/725

(52) U.S. Cl. CPC H04N 1/00307; H04N 1/00204; H04M 1/72519; G06F 3/1431; G09G 5/006; H04N 2201/0094; H04N 2201/0096

(57) ABSTRACT

A portable terminal capable of remotely controlling a device control apparatus with a simple system configuration. The portable terminal is connected to a device control apparatus through a network. Virtual device identification information used for causing the device control apparatus to identify a predetermined function of the portable terminal is stored as an internal device connected to the portable terminal. A virtualization control unit converts data communication between the internal device and the portable terminal into a first data format and converts data communication between the device control apparatus and the portable terminal into a second data format, when subjecting the internal device, identified by the device control apparatus according to selected one of virtual device identification information, to virtualization control of controlling the internal device as if the internal device were connected to the device control apparatus according to a control request from the device control apparatus concerned.

### FIELD OF THE INVENTION

The present invention relates to a portable terminal capable of operating a device control apparatus connected through a network, and a control method for this portable terminal.

### DESCRIPTION OF THE RELATED ART

Conventionally, there is a known technique that remotely controls settings about device control apparatuses, such as a printer, storage, and a scanner, from a portable terminal, such as a mobile phone, a PDA, or a smart phone through a network.

For example, a system in which a display size of a portable terminal is registered in a server apparatus and setting screen data according to the display size of the portable terminal is transmitted from the server apparatus is disclosed in Japanese Laid-Open Patent Publication (Kokai) No. 2003-11463. A user displays the transmitted setting screen data on the portable terminal, and remotely operates the device control unit.

However, since the system disclosed in the patent document 1 needs the server apparatus, there is a problem in that the system becomes complicated.

### SUMMARY OF THE INVENTION

An object of the present invention is to provide a portable terminal that is capable of remotely controlling a device control apparatus with a simple system configuration, and a control method for the portable terminal.

To attain the above object, the portable terminal according to the present invention provides a portable terminal connected to a device control apparatus through a network, the portable terminal comprising an inputting unit configured to perform a predetermined operation, and an identification information storage unit configured to store virtual device identification information used for causing the device control apparatus to identify a predetermined function of the portable terminal as an internal device connected to the portable terminal, comprising: a processer configured to execute: an identification information selecting task that selects at least one of the virtual device identification information stored in the identification information storage unit, when the predetermined operation is performed by the inputting unit; an identification information transmitting task that transmits to the device control apparatus the one of the virtual device identification information that is selected by identification information selecting task; and a virtualization control task that converts data communication between the internal device and the portable terminal into a first data format and convert data communication between the device control apparatus and the portable terminal into a second data format, when subjecting the internal device, identified by the device control apparatus according to the selected one of virtual device identification information, to virtualization control of controlling the internal device as if the internal device were connected to the device control apparatus according to a control request from the device control apparatus concerned.

The control method for a portable terminal according to the present invention provides a control method of a portable terminal connected to a device control apparatus through a network, the portable terminal comprising an inputting unit configured to perform a predetermined operation, an identification information storage unit configured to store virtual device identification information used for causing the device control apparatus to identify a predetermined function of the portable terminal as an internal device connected to the portable terminal, the control method comprising: an identification information selecting step of selecting at least one of the virtual device identification information stored in the identification information storage unit, when the predetermined operation is performed by the inputting step; an identification information transmitting step of transmitting to the device control apparatus the one of the virtual device identification information that is selected by identification information selecting step; and a virtualization control step of converting data communication between the internal device and the portable terminal into a first data format and converting data communication between the device control apparatus and the portable terminal into a second data format, when subjecting the internal device, identified by the device control apparatus according to the selected one of virtual device identification information, to virtualization control of controlling the internal device as if the internal device were connected to the device control apparatus according to a control request from the device control apparatus concerned.

According to the present invention, since the internal device of the portable terminal is subjected to virtualization control from the device control apparatus on the network, it becomes possible to operate the device control apparatus using the internal device of the portable terminal with a simple system configuration.

Further features of the present invention will become apparent from the following description of an exemplary embodiment with reference to the attached drawings

### BRIEF DESCRIPTION OF THE DRAWINGS

FIG. 1 is a block diagram showing an example of a device control system according to a first embodiment of the present invention.

FIG. 2 is a table showing an example of virtual device identification information shown in FIG. 1.

FIG. 3 is a sequence diagram for describing operations at the time when a touch panel of a portable terminal is subjected to virtualization control from a device control apparatus in the device control system shown in FIG. 1.

FIG. 4A is a drawing showing an example of an operation screen displayed on the touch panel of the portable terminal shown in FIG. 1.

FIG. 4B is a drawing showing an example of an operation screen displayed when a connection button is depressed on the operation screen shown in FIG. 4A.

FIG. 5 is a block diagram showing an example of a device control system according to a second embodiment of the present invention.

FIG. 6 is a sequence diagram for describing operations at the time when a touch panel of a portable terminal is subjected to virtualization control from a device control apparatus in the device control system shown in FIG. 5.

### DESCRIPTION OF THE EMBODIMENTS

Hereafter, an example of a device control system according to an embodiment of the present invention will be described with reference to the drawings.

### First Embodiment

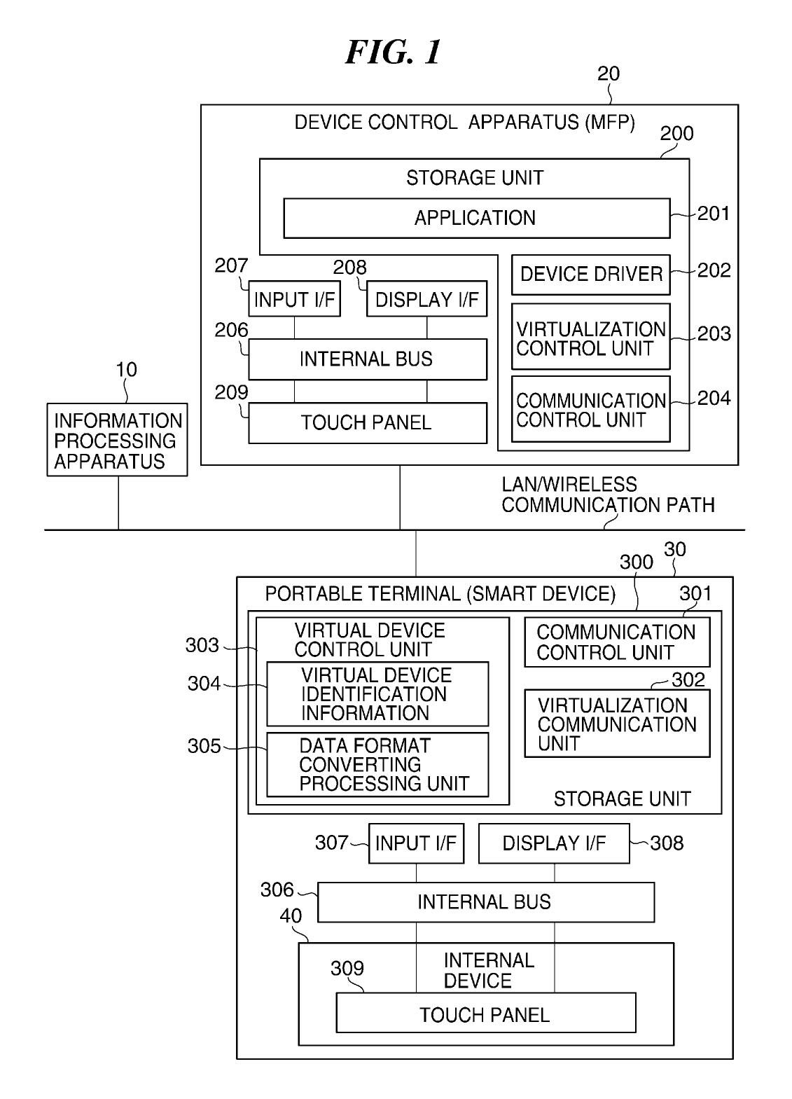

FIG. 1 is a block diagram showing an example of a device control system according to a first embodiment of the present invention.

In the illustrated device control system, an information processing apparatus 10 and a device control apparatus 20 are connected through a local area network (LAN) of a wire line or a wireless line. Moreover, the device control apparatus 20 and a portable terminal 30 are connected through a wireless communication path, such as a 3G line and Wi-Fi (registered trademark).

The information processing apparatuses 10 is an apparatus like a personal computer (PC) used by a user. The device control apparatus 20 is a peripheral device like a printer or a multifunctional composite machine (MFP: Multi Function Peripheral), for example, and executes functions, such as printing, scanning, and copying according to a command from the information processing apparatus 10 or the portable terminal 30, or by the device control apparatus 20 independently.

Furthermore, although the number of each of the information processing apparatus 10, the device control apparatus 20, and the portable terminal 30 shown is only one in the device control system shown in FIG. 1, the numbers of the information processing apparatus 10, the device control apparatus 20, and the portable terminal 30 are not limited to the illustrated example.

The device control apparatus 20 is a peripheral device, such as a printer or a multifunctional composite machine (MFP: Multi Function Peripheral), for example, and is provided with a CPU, memories, a communication unit (not shown), a storage unit 200, and a touch panel 209 as a hardware configuration. The touch panel 209 combines an input function and a display function, and is connected to an input I/F (interface) 207 and a display I/F 208 through an internal bus 206 individually.

The CPU manages the entire control of the device control apparatus 20. The memories are RAM, ROM, etc. The communication unit is an interface for connecting with the LAN and the wireless communication path, and transmits and receives data with the information processing apparatus 10 and the portable terminal 30.

In the storage unit 200, an operating system (hereinafter referred to as OS, not shown), a communication control unit 204, a virtualization control unit 203, a device driver 202, and an application 201 that are software modules are stored, and software modules concerning other functions are stored. Furthermore, these software modules are read onto a memory and operate under the control of the CPU.

The application 201 is a software program for controlling an internal device 40 of the portable terminal 30 by instructing a data input-output request to the device driver 202.

The device driver 202 converts a data input-output request from the OS or the application 201 into data (hereinafter referred to as a control command) in a data format corresponding to the internal device 40 of the portable terminal 30, and transmits the control command concerned to the virtualization control unit 203. Further, the device driver 202 notifies the application 201 of a response to the control command. The device driver 202 is a software module provided by a manufacturing company in general, and the device control apparatus 20 can control the internal device 40 of the portable terminal 30 by the device driver 202 corresponding to each device.

The virtualization control unit 203 converts the control command (i.e., the data input-output request) transmitted from the device driver 202 into packet data based on a USB data format (hereinafter referred to as USB data). Moreover, the virtualization control unit 203 converts the USB data transmitted from the communication control unit 204 into the same data format as the control command, and transmits the converted USB data to the device driver 202.

Further, the virtualization control unit 203 has a function that simulates a behavior similar to that in a case where the internal device 40 of the portable terminal 30 shall be directly connected with the device control apparatus 20 (local connection) in response to a data transmission-reception request to the internal device 40 of the portable terminal 30 (hereinafter referred to as virtualization control). With this virtualization control, the device control apparatus 20 can transmit and receive data while recognizing as the same state as the case where the internal device 40 of the portable terminal 30 (a display function and an input function of a touch panel 309) is locally connected.

The communication control unit 204 performs a converting process between the USB data transmitted from the virtualization control unit 203 and the network packet at the time of communicating with the portable terminal 30, and controls transmission and reception of data with the portable terminal 30. Moreover, the communication control unit 204 controls start and disconnection of a session with the portable terminal 30 in response to the data transmission-reception request transmitted from the application 201 or the device driver 202 through the virtualization control unit 203.

The portable terminal 30 is an apparatus, such as a mobile phone, a PDA, or a smart phone, for example and is provided with a CPU, a memory, a communication unit (not shown), a storage unit 300, and the touch panel 309 as a hardware configuration. The touch panel 309 combines an input function and a display function, and is connected to an input I/F (interface) 307 and a display I/F 308 through an internal bus 306 individually. In this embodiment, the touch panel 309 is positioned as the internal device 40 of the portable terminal 30. Furthermore, an input device and a display device may be provided in place of the touch panel 309.

In the storage unit 300, an OS (not shown), a communication control unit 301, a virtualization communication unit 302, and a virtual device control unit 303 that are software modules are stored, and software concerning another function is stored. Furthermore, these software modules are read onto the memory and operate under the control of the CPU.

The communication control unit 301 controls transmission and reception of input-output data etc. that are performed with the device control apparatus 20. The virtualization communication unit 302 controls the internal device 40 according to (by interlocking with) the control request from the virtualization control unit 203 of the device control apparatus 20 in order to enable controlling while recognizing as if the internal device 40 with which the portable terminal 30 is provided is locally connected to the device control apparatus 20.

The virtual device control unit 303 includes virtual device identification information 304 and a data format converting processing unit 305. Further, the virtual device control unit 303 is provided with a user interface that switches the internal device 40 with which the portable terminal 30 is provided to a virtual USB device.

The virtual device identification information 304 is used in order to make the device control apparatus 20 recognize the internal device 40. Since the touch panel 309 as the internal device 40 does not have information equivalent to the individual identification information, the device control apparatus 20 cannot recognize the internal device 40 without the virtual device identification information 304.

Accordingly, the virtual device identification information 304 equivalent to the individual identification information is allocated to each internal device 40 to make the device control apparatus 20 recognize the touch panel 309 as a USB device. Here, the virtual device identification information 304 is simulatively created configuration information (hereinafter referred to as a USB descriptor) that defines the data structure of the USB device.

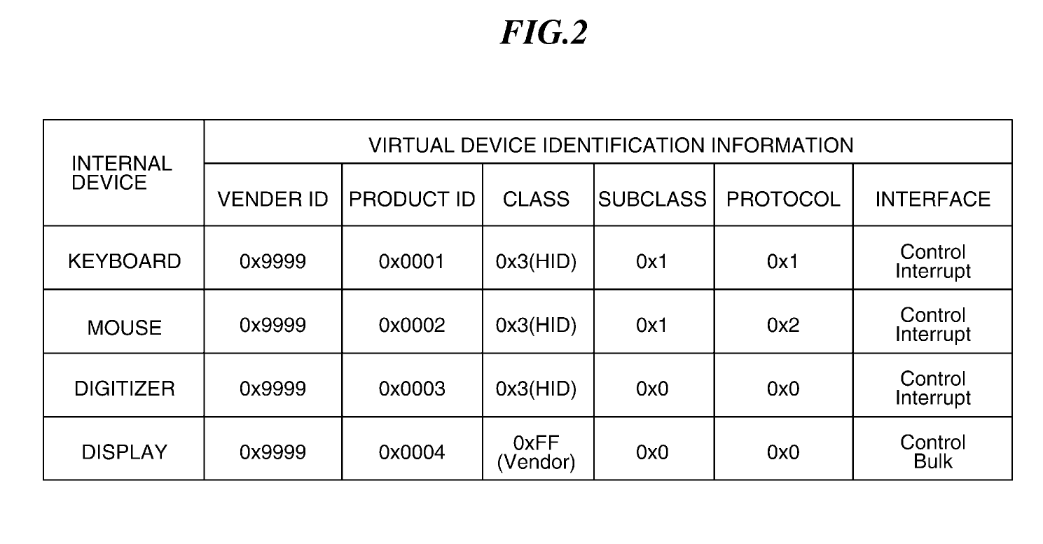

FIG. 2 is a table showing an example of the virtual device identification information 304 shown in FIG. 1.

The touch panel 309 is provided with an input function and a display function collectively, the input function corresponds to a keyboard, a mouse, and a digitizer, and the display function corresponds to a display. In order to recognize the keyboard, mouse, digitizer, and display as USB devices, pseudo USB descriptors (i.e., the virtual device identification information) are allocated.

The pseudo USB descriptor shown in FIG. 2 consists of a vendor ID, a product ID, a serial number, a class, a subclass, a protocol, and an interface.

The vendor ID is identification information allocated for each enterprise or each manufacturing company, and the product ID is a code assigned to each product or each model by an enterprise or a company having the vendor ID so as not to overlap. In this embodiment, the vendor ID and the product ID that are allocated to the device control apparatus 20 are used.

Moreover, the class, subclass, protocol, and interface are information specified by the USB standard specification according to a type of a device, such as a keyboard, a mouse, a digitizer, and a display. Then, the pseudo USB descriptor that associates the vendor ID and product ID with the class, subclass, protocol, and interface is created, and is held (stored) by the virtual device control unit 303 as the virtual device identification information 304.

When a connecting operation for starting connection to the internal device 40 is performed by a user's operation etc. to the touch panel 309, the virtual device control unit 303 transmits the virtual device identification information 304 to the virtualization communication unit 302. On the other hand, when an ending operation is performed, the virtual device control unit 303 terminates the virtualization control of the internal device 40.

The data format converting processing unit 305 performs the converting process between the packet data (USB data) based on the USB data format transmitted from the virtualization communication unit 302 and the data of the data format that can be processed by the internal device 40, and enables the transmission and reception of the data between the device control apparatus 20, and the input I/F 307 and the display I/F 308 that are connected to the internal device 40.

Next, the virtualization control of an input function/display function and data-format conversion will be described. In this embodiment, the virtual device control unit 303 transmits the USB descriptor that identifies an HID class to the virtualization communication unit 302 as the virtual device identification information 304 concerning the input function of the touch panel. Moreover, the data format converting processing unit 305 converts the input data input from the input function of the touch panel into the USB data of the HID class, and transmits to the virtualization communication unit 302 through the input I/F 307.

Further, the virtual device control unit 303 transmits the USB descriptor that identifies vendor specific information (vendor class) to the virtualization communication unit 302 as the virtual device identification information 304 concerning the display function of the touch panel. Moreover, the data format converting processing unit 305 converts the USB data transmitted from the virtualization communication unit 302 into the data format of the display function of the touch panel, and transmits to the touch panel 309 through the display I/F 308. Furthermore, when the USB data transmitted from the virtualization communication unit 302 can be passed without performing data conversion, it is transmitted to the touch panel 309 through the display I/F 308 without performing data conversion.

For example, when the device control apparatus 20 on the network is remotely controlled from the touch panel 309 with which the portable terminal 30 is provided, the virtual device identification information 304 that was mentioned above is transmitted to the device control apparatus 20 on the network in response to the change operation from the touch panel 309, and the touch panel 309 (i.e., keyboard input and display output) as the internal device 40 switches to the virtualization control from the device control apparatus 20 on the network. This enables the device control apparatus 20 on the network to be remotely operated from the touch panel 309 with which the portable terminal 30 is provided.

As mentioned above, the internal device 40 is an input/output device (touch panel) equipped with an input function and a display function, and is connected to the input I/F 307 and the display I/F 308 through the internal bus 306 individually. The input function that processes an input from the touch panel 309 and the display function that processes displaying on the touch panel 309 are used at the time of an operation of the portable terminal 30.

The internal bus 306 mutually connects the blocks of the portable terminal 30, transmits and receives various kinds of data, and supplies electric power. Furthermore, in this embodiment, although the internal device 40 is described as the touch panel 309, this is not limited, it may be a storage unit (not shown) in the portable terminal 30.

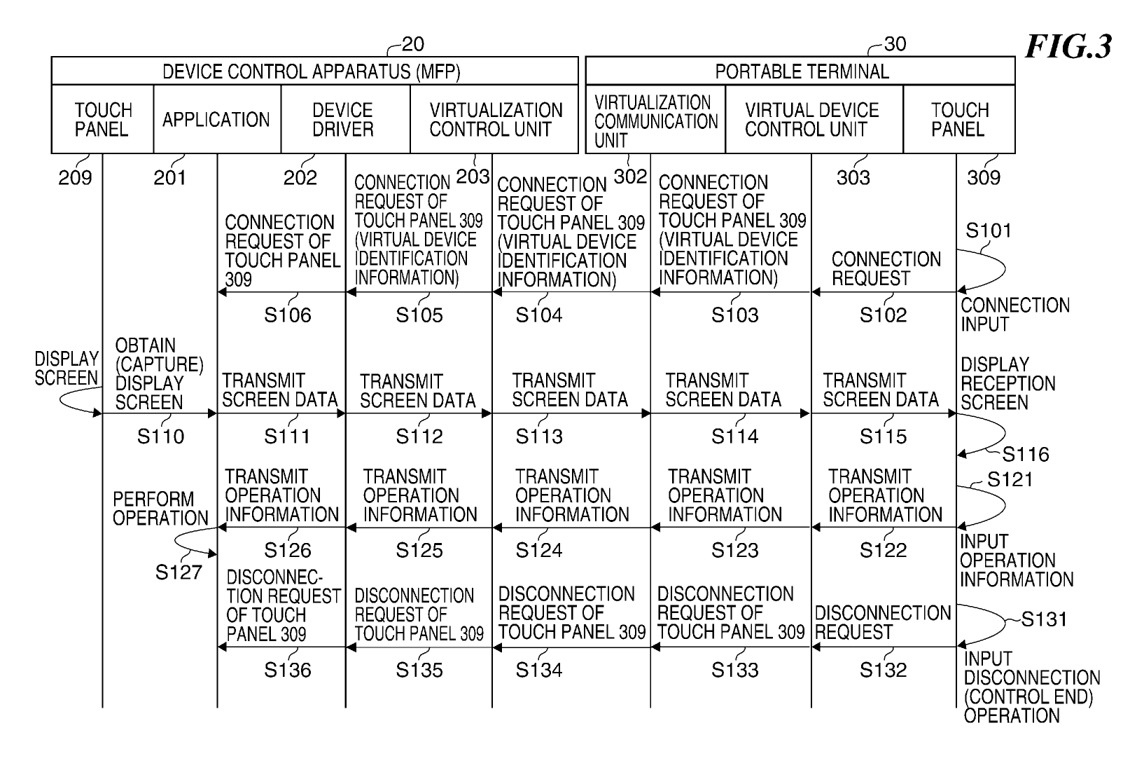

Next, a sequence of the device control system will be described. FIG. 3 is a sequence diagram for describing operations at the time when the device control apparatus 20 subjects the internal device 40 of the portable terminal 30 to virtualization control in the device control system shown in FIG. 1.

The virtualization control of the internal device 40 (touch panel 309) starts by a user's operation from the portable terminal 30.

First, a user makes the touch panel 309 display an operation screen by a predetermined operation, and makes the connection with the internal device 40 (touch panel 309) start by operating (connecting operation) the operation screen (step S101).

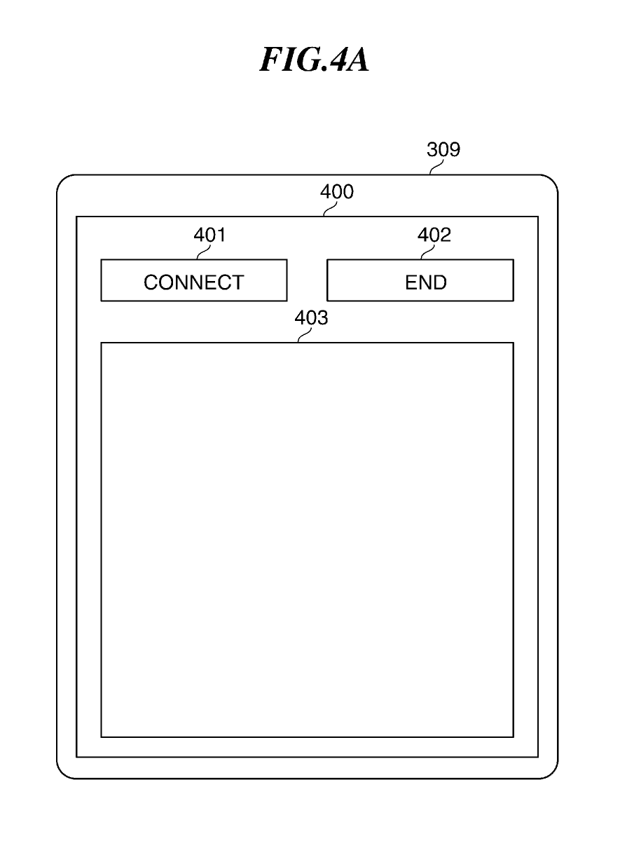

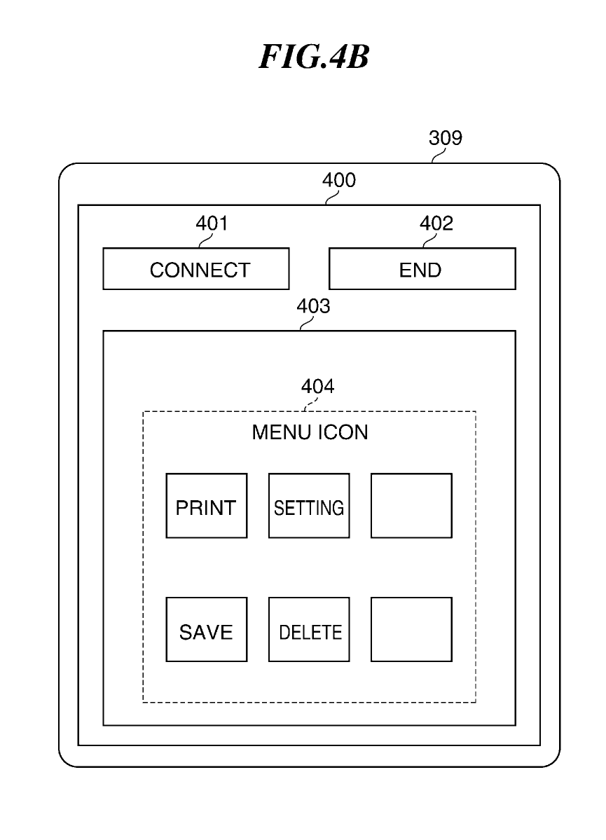

FIG. 4A and FIG. 4B are views showing examples of the operation screen 400 on which start and end of the virtualization control are instructed and that are displayed on the touch panel 309 of the portable terminal 30. FIG. 4A shows the operation screen 400 displayed on the touch panel 309 of the portable terminal 30 before the start of the virtualization control, and FIG. 4B shows the operation screen 400 displayed on the touch panel 309 of the portable terminal 30 after the start of the virtualization control.

When the user performs a predetermined operation, the operation screen 400 shown in FIG. 4A is displayed on the touch panel 309. The operation screen 400 consists of a connection button 401 for instructing to start the virtualization control of the internal device 40, an end button 402 for instructing the termination (disconnection of the virtualization control), and a receiving screen display areas 403 for displaying screen data transmitted from the device control apparatus 20.

When the user depresses the connection button 401 shown in FIG. 4, the virtualization control of the internal device 40 by the device control apparatus 20 is started, and the display state is switched from FIG. 4A to FIG. 4B. At this time, menu icons 404 of the device control apparatus 20, for example, are displayed on the receiving screen display area 403 as the screen data transmitted from the device control apparatus 20. Furthermore, this screen data was converted into the data format that could be displayed on the touch panel 309 by the data format converting processing unit 305.

Upon the user's input to the touch panel 309 according to the menu icons 404 that are displayed on the receiving-screen display area 403, the user can operate the device control apparatus 20 by using the touch panel 309 of the portable terminal 30.

On the other hand, when the user depresses the end button 402 shown in FIG. 4B, the virtualization control of the internal device 40 by the device control apparatus 20 is ended (disconnected), and the display state in the receiving-screen display area 403 is switched from FIG. 4B to FIG. 4A.

Referring back to the description of the sequence in FIG. 3, when the user depresses the connection button 401 displayed on the operation screen 400 of the touch panel 309 of the portable terminal 30 (step S101), a connection request is transmitted from the touch panel 309 to the virtual device control unit 303 (step S102).

The virtual device control unit 303 selects the virtual device identification information 304 concerning the touch panel 309, and transmits to the virtualization communication unit 302, and notifies of the connection request (transmission of the virtual device identification information: step S103). For example, four USB descriptors of the keyboard, mouse, digitizer, and display described in FIG. 2 are transmitted as the virtual device identification information 304.

Next, the virtualization communication unit 302 notifies the virtualization control unit 203 of the device control apparatus 20 of the connection request of the touch panel 309 (step S104).

The virtualization control unit 203 of the device control apparatus 20 notifies the device driver 202 of the virtual device identification information 304 concerning the touch panel 309 (internal device 40) received from the virtualization communication unit 302 of the portable terminal 30 (step S105).

The application 201 receives the connection request of the touch panel 309 (internal device 40) from the device driver 202 (step S106). When receiving the connection request of the touch panel 309 (internal device 40), the application 201 instructs the virtualization control unit 203 to start the virtualization control of the touch panel 309 (internal device 40), and starts the virtualization control of the touch panel 309 (internal device 40) of the portable terminal 30. Then, the device control apparatus 20 generates and activates software modules required for the virtualization control, and starts connection with the touch panel 309 (internal device 40) using these software modules.

When the connection between the touch panel 309 (internal device 40) and the application 201 is started, the application 201 captures the display screen on the touch panel 209, and obtains screen data (step S110).

The application 201 transmits the obtained screen data on the touch panel 209 to the device driver 202 (step S111). The device driver 202 transmits the screen data received from the application 201 to the virtualization control unit 203 (step S112).

The virtualization control unit 203 transmits the screen data to the virtualization communication unit 302 of the portable terminal 30 (step S113). The virtualization communication unit 302 transmits the screen data to the virtual device control unit 303 (step S114).

The data format converting processing unit 305 of the virtual device control unit 303 converts the USB data transmitted from the virtualization communication unit 302 into the data format of the touch panel 309 (a first data format), and transmits to the touch panel 309 through the display I/F 308 (step S115). The touch panel 309 displays a screen based on the screen data transmitted from the device control apparatus 20, and becomes an input waiting state to the device control apparatus 20 (step S116). Furthermore, when the USB data transmitted from the virtualization communication unit 302 can be passed without performing data conversion, it is transmitted to the touch panel 309 through the display I/F 308 without performing data conversion. Moreover, when all the screen data obtained is not transmitted and only difference from the screen data that was transmitted last time is transmitted in the above-mentioned step S111, the differential screen data is composited with the screen data that has been already received, and is displayed here.

The user inputs the operation information for remotely operating the device control apparatus 20 using the touch panel 309 of the portable terminal 30 (step S121).

Subsequently, the touch panel 309 transmits the operation information to the virtual device control unit 303 through the input I/F 307 (step S122).

The virtual device control unit 303 converts the operation information (input data) received through the input I/F 307 into the USB data (a second data format), and transmits to the virtualization communication unit 302 (step S123).

The virtualization communication unit 302 transmits the received operation information to the virtualization control unit 203 of the device control apparatus 20 (step S124). The virtualization control unit 203 of the device control apparatus 20 transmits the received operation information to the device driver 202 (step S125). The device driver 202 transmits the operation information received from the virtualization control unit 203 to the application 201 (step S126).

Subsequently, the application 201 executes the operation (process) corresponding to the operation information received from the device driver 202 (step S127). The device control apparatus 20 displays the execution result of the process (function) on the touch panel 209. This screen data displayed on the touch panel 209 is transmitted to the portable terminal 30 and is displayed on the touch panel 309 of the portable terminal 30 in the same manner as the above mentioned step S107 through the step S116.

Furthermore, when the connection between the touch panel 309 (internal device 40) and the application 201 is started in the step S106, the process (screen transfer process) in the step S107 through the step S116 and the process (remote operation process) in the step S121 through the step S127 are repeated by asynchronously (in parallel) until the connection is disconnected (terminated) in step S136 mentioned later. At this time, the virtualization communication unit 302 and the virtual device control unit 303 perform data transmission and reception between the internal device 40 and the device control apparatus 20 through the network.

When ending the virtualization control of the internal device 40 of the portable terminal 30 by the device control apparatus 20, the user depresses the end button 402 shown in FIG. 4B (step S131). As a result of this, the touch panel 309 requires disconnection of communication (end of control) from the virtual device control unit 303 (step S132). The virtual device control unit 303 notifies the virtualization communication unit 302 of a disconnection request (step S133).

Subsequently, the virtualization communication unit 302 notifies the virtualization control unit 203 of the device control apparatus 20 of the disconnection request (end of control) of the internal device 40 (step S134). The virtualization control unit 203 notifies the device driver 202 of the disconnection request received from the virtualization communication unit 302 of the portable terminal 30 (step S135).

The device driver 202 notifies the application 201 of the disconnection request received from the virtualization control unit 203 (step S136), and ends the control of the touch panel 309 (internal device 40). Accordingly, the communication between the application 201 and the touch panel 309 (internal device 40) is disconnected.

As a result of this, the virtualization control of the internal device 40 of the portable terminal 30 by the device control apparatus 20 is ended, and the operation screen 400 of the portable terminal 30 switches from FIG. 4B to the display state in FIG. 4A.

As mentioned above, in the first embodiment of the present invention, since the device control apparatus 20 subjects the internal device 40 of the portable terminal 30 to virtualization control, and can simulate its behavior similar to that in a case where the internal device 40 is directly connected using the device driver 202 (local connection), a user can use the device control apparatus 20 using the internal device 40 (for example, a touch panel) with which the portable terminal 30 is provided.

### Second Embodiment

Subsequently, one example of a device control system according to a second embodiment of the present invention will be described.

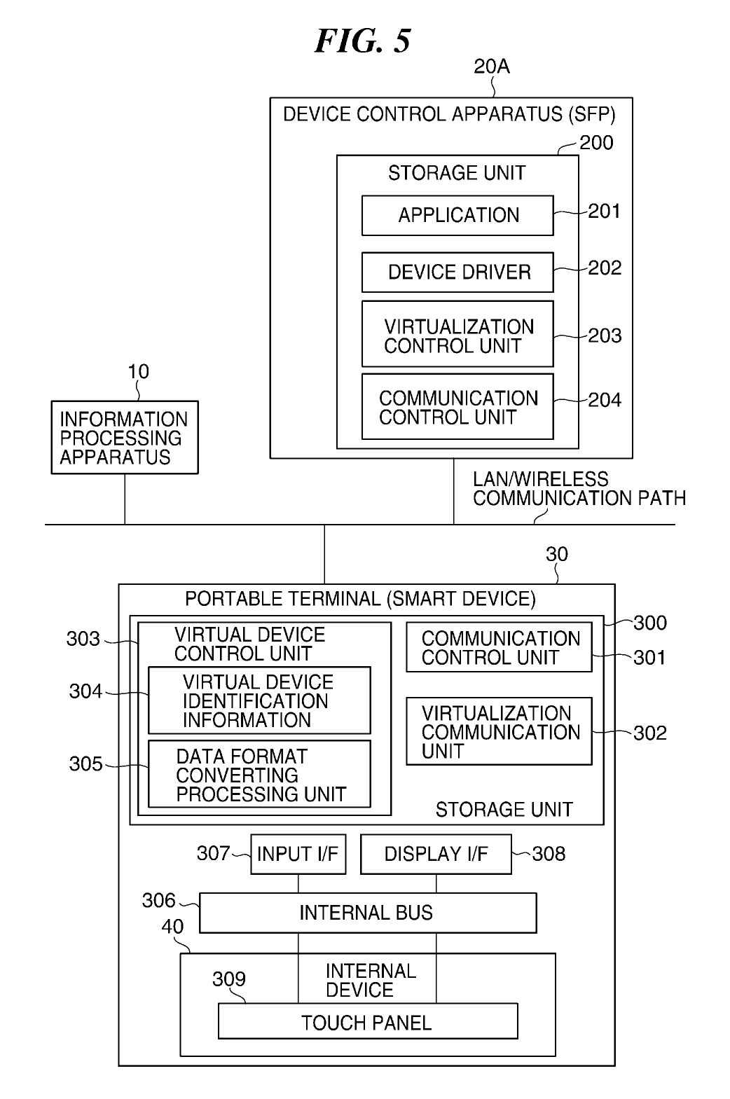

FIG. 5 is a block diagram showing an example of the device control system according to the second embodiment of the present invention. Furthermore, the same reference numbers are applied to the configuration members that are same as that in the device control system shown in FIG. 1, and the descriptions are omitted.

Although the device control apparatus 20 was described as the MFP that is provided with the touch panel in the first embodiment, it will be described as an MFP that is not provided with a touch panel, or as a single function peripheral device (SFP: Single Function Peripheral) in the second embodiment. In the device control system shown in FIG. 5, the device control apparatus 20A is a single function peripheral device, and the storage unit 200 is provided with the application 201, the device driver 202, the virtualization control unit 203, and the communication control unit 204.

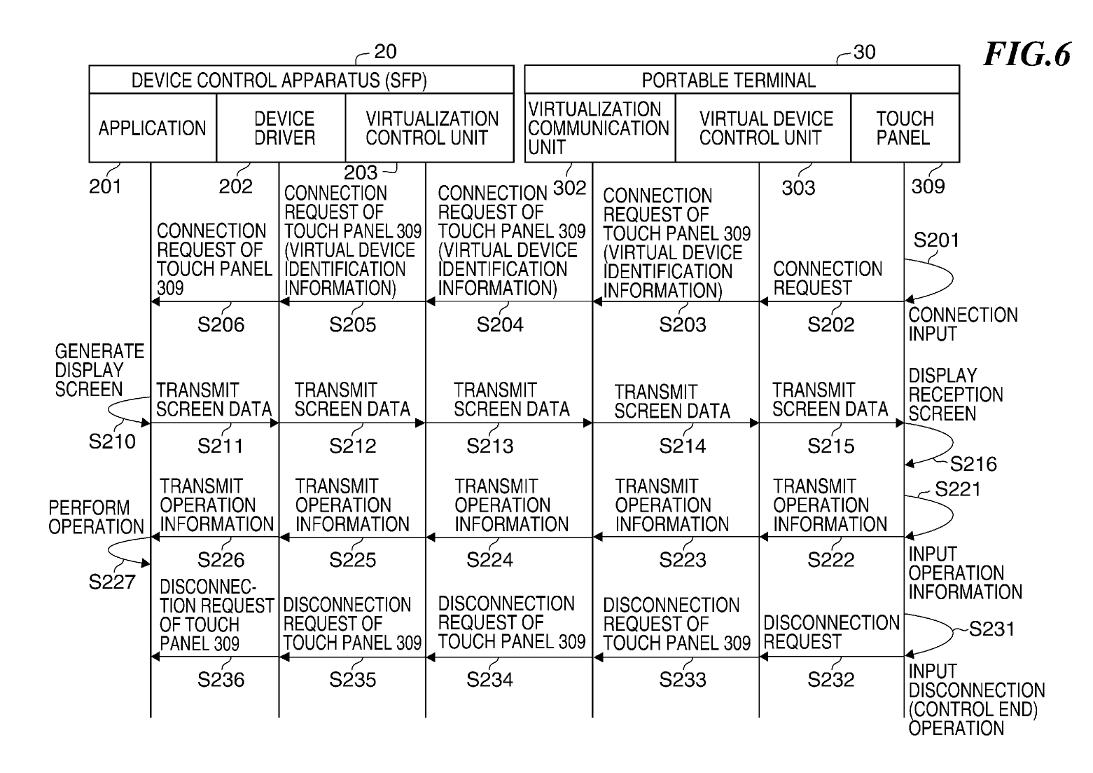

FIG. 6 is a sequence diagram for describing operations at the time when a touch panel of a portable terminal is subjected to virtualization control from the device control apparatus to use a function with which the device control apparatus (SFP) 20A is provided in the device control system shown in FIG. 5.

Since the process in step S201 through step S206 is similar to the process in the step S101 through the step S106 described in the first embodiment, the description is omitted. When the connection between the touch panel 309 (internal device 40) and the application 201 is started in the step S201 through the step S206, the application 201 of the device control apparatus 20 generates a display screen in response to the connection request of the touch panel 309 of the portable terminal 30 (step S210).

Since the process in and after step S211 (step S211 through step S236) is similar to the process in the step S111 through the step S136 described in the first embodiment, the description is omitted.

As mentioned above, in the second embodiment of the present invention, since the device control apparatus 20A is not provided with a touch panel, the display screen generation process (the step S210 in FIG. 6) is performed in place of the display screen obtaining process (the step S107 in FIG. 3) described in the first embodiment. Accordingly, since the device control apparatus 20A subjects the internal device 40 of the portable terminal 30 to virtualization control, and can simulate its behavior similar to that in a case where the internal device 40 is directly connected (locally connected) using the device driver 202, a user can use the device control apparatus 20A by substituting the internal device 40 (for example, a touch panel) with which the portable terminal 30 is provided as a display device (display function) of the device control apparatus 20A even if the device control apparatus 20A (SFP) is not provided with a display device (display function).

Although the embodiments of the invention have been described, the present invention is not limited to the above-mentioned embodiments, the present invention includes various modifications as long as the concept of the invention is not deviated.

For example, the application 201 of the device control apparatus may switch the control contents described in the first embodiment and the second embodiment by means of a function of the device control apparatus in which the application itself is installed. Consequently, there is no need to develop respective different applications for the device control apparatus 20 with a touch panel and the device control apparatus 20A without a touch panel, and the application developed for the device control apparatus 20 with a touch panel becomes possible to be operated on the device control apparatus 20A without a touch panel by using the function of the internal device 40 of the portable terminal 30, which can reduce the development cost of applications.

Although the device that is subjected to virtualization control by the device control apparatus is described as the internal device 40 (example: touch panel 309) of the portable terminal 30, it may be a storage device, such as a flash memory (example: SD memory card) built in the portable terminal 30, or a camera etc. built in the portable terminal 30.

When an external device (not shown) is connected to the portable terminal 30 through a communication I/F (not shown), the device control apparatus 20 subjects the external device of the portable terminal 30 to virtualization control, and can perform data transmission and reception with the external device. Furthermore, the external device is an input device, such as a keyboard, a mouse, a digitizer, or a ten-key pad, a display unit like an LCD, or a storage unit like a USB memory, etc. The external device is connected to the device control apparatus 20 through a communication I/F like a USB interface etc.

The functions of the above mentioned embodiments are made into a control method, and this control method may be executed by the device control apparatus. Moreover, a program having the functions of the above mentioned embodiments is made into a control program, and the control program concerned may be executed by a computer with which the device control apparatus is provided. Furthermore, the control program is recorded into a computer-readable storage medium, for example.

The embodiment of the present invention can be attained by a computer of a system or an apparatus (or a device like a CPU or an MPU) that reads and executes a program stored in a storage unit in order to achieve the function of the above-mentioned embodiment, or can be attained by a method by which steps are executed by a computer of a system or an apparatus that reads and executes a program stored in a storage unit in order to achieve the function of the above-mentioned embodiment, for example. For this, the program is supplied to the computer through a network or from various storage media that play a role of the storage unit (for example, a computer-readable medium), for example.

Although the present invention is described with reference to exemplary embodiments, it should not be understood to be restricted to the disclosed exemplary embodiments. The following claims should be most widely interpreted so as to include all modified examples, and an equivalent configuration and function.

This application is a bypass continuation application of PCT International Application PCT/JP2013/085326 filed on Dec. 25, 2013 which is based on and claims priority from Japanese Patent Application No. 2012-284993, filed Dec. 27, 2012, the contents of which are hereby incorporated by reference herein in its entirety.

What is claimed is:

1. A portable terminal connected to a device control apparatus through a network, the portable terminal comprising an inputting unit configured to perform a predetermined operation, and an identification information storage unit configured to store virtual device identification information used for causing the device control apparatus to identify a predetermined function of the portable terminal as an internal device connected to the portable terminal, comprising:
a processer configured to execute:
an identification information selecting task that selects at least one of the virtual device identification information stored in the identification information storage unit, when the predetermined operation is performed by the inputting unit;
an identification information transmitting task that transmits to the device control apparatus the one of the virtual device identification information that is selected by identification information selecting task; and
a virtualization control task that converts data communication between the internal device and the portable terminal into a first data format and convert data communication between the device control apparatus and the portable terminal into a second data format, when subjecting the internal device, identified by the device control apparatus according to the selected one of virtual device identification information, to virtualization control of controlling the internal device as if the internal device were connected to the device control apparatus according to a control request from the device control apparatus concerned.

2. The portable terminal according to claim 1, wherein the virtualization control unit ends control of the internal device, when a predetermined end operation is performed in the portable terminal.

3. The portable terminal according to claim 1, wherein the identification information transmitting unit further transmits, when a device is connected to the portable terminal, individual identification information transmitted from the device to the device control apparatus, and
the virtualization control unit further subjects the device, identified by the device control apparatus based on the individual identification information, to virtualization control according to a control request from the device control apparatus.

4. A control method of a portable terminal connected to a device control apparatus through a network, the portable terminal comprising an inputting unit configured to perform a predetermined operation, an identification information storage unit configured to store virtual device identification information used for causing the device control apparatus to identify a predetermined function of the portable terminal as an internal device connected to the portable terminal,
the control method comprising:
an identification information selecting step of selecting at least one of the virtual device identification information stored in the identification information storage unit, when the predetermined operation is performed by the inputting step;
an identification information transmitting step of transmitting to the device control apparatus the one of the virtual device identification information that is selected by identification information selecting step; and
a virtualization control step of converting data communication between the internal device and the portable terminal into a first data format and converting data communication between the device control apparatus and the portable terminal into a second data format, when subjecting the internal device, identified by the device control apparatus according to the selected one of virtual device identification information, to virtualization control of controlling the internal device as if the internal device were connected to the device control apparatus according to a control request from the device control apparatus concerned.

5. The control method according to claim 4, wherein the virtualization control step ends control of the internal device, when a predetermined end operation is performed in the portable terminal.

6. The control method according to claim 4, wherein the identification information transmitting step further transmits, when a device is connected to the portable terminal, individual identification information transmitted from the device to the device control apparatus, and
the virtualization control step further subjects the device, identified by the device control apparatus based on the individual identification information, to virtualization control according to a control request from the device control apparatus.
